(19) United States
(12) Patent Application Publication
(10) Pub. No.: US 2018/0345265 A1
(43) Pub. Date: Dec. 6, 2018

(54) Nb Oxide Embedded In Carbon And Its Use For Making Active And Durable Oxygen Reduction Electrocatalysts

(71) Applicant: Brookhaven Science Associates, LLC, Upton, NY (US)

(72) Inventors: Jia Xu Wang, East Setauket, NY (US); Radoslav R. Adzic, East Setauket, NY (US); Zhong Ma, Waterloo (CA); Zhongwei Chen, Waterloo (CA); Liang Song, Port Jefferson Station, NY (US)

(21) Appl. No.: 16/000,494

(22) Filed: Jun. 5, 2018

Related U.S. Application Data
(60) Provisional application No. 62/515,214, filed on Jun. 5, 2017.

(51) Int. Cl. B01J 35/00; B01J 35/02; B01J 35/10; B01J 37/02; B01J 37/04; B01J 37/18; B01J 37/34; B01J 21/18; B01J 23/20; B01J 23/42

(52) U.S. Cl. CPC B01J 35/0006; B01J 35/023; B01J 35/1061; B01J 37/0213; B01J 37/0225; B01J 23/42; B01J 37/18; B01J 37/348; B01J 21/18; B01J 23/20; B01J 37/04

(57) ABSTRACT

The present particles, compositions and methods are Nb-oxide embedded carbon based electrocatalysts. In one embodiment, a carbon based support particle is provided having NbOₓ (0 ≤x≤2 is average value of amorphous low-oxidation-state niobium oxides) and a catalytically active metal deposited thereupon. In one embodiment, a method is provided of embedding niobium oxides into pores of carbon black, which involves filling about 4 nm pores on Ketjenblack EC 600JD (KB) with Nb(V) ethoxide by sonication, and decomposing/reducing dried Nb(V) precursor in carbon to ≤5 nm particles of NbOₓ. The embedded, small metal or metal oxide particles over porous carbon surface may find applications in fuel cell and battery technologies. The present compositions can be used for fabricating active and durable catalysts for oxygen reduction reaction (ORR).

### CROSS-REFERENCE TO RELATED APPLICATION

This application claims the benefit of U.S. Provisional Application No. 62/515,214, filed Jun. 5, 2017, which is hereby incorporated by reference in its entirety.

### STATEMENT OF GOVERNMENT RIGHTS

This invention was made with Government support under contract number DE-SC0012704 awarded by the U.S. Department of Energy. The Government has certain rights in the invention.

### FIELD OF THE INVENTION

This disclosure relates generally to carbon-based nanoparticles. In particular, it relates to nanoparticles for use as electrocatalysts.

### BACKGROUND

Carbon black is often used as support for platinum-based nanocatalysts in polymer electrolyte membrane fuel cells (PEMFCs) because of its high specific surface area, high electrical conductivity and low cost. However, the corrosion of the carbon may occur, especially under automotive start/stop conditions. The high transient voltage up to 1.5 V at the cathode may accelerate the carbon degradation, resulting in agglomeration of Pt particles due to their detachment from the carbon surface. The loss of electrochemical surface area of Pt catalysts, together with lowered transport properties of the porous catalyst layer, may result in PEMFC performance decay. [Yu, X.; Ye, S. J. Power Sources 2007, 172 (1), 145-154]

Therefore, there remains a need for platinum or metallic-based nanocatalysts having corrosion resistance at high potentials and improved durability.

### SUMMARY OF THE INVENTION

In one embodiment, the present carbon support comprising carbon particles having a surface with a plurality of pores. These surface pores are utilized for embedding first metal or first metal compound particles into the conductive carbon surface with the size of embedded particles controlled by the amount of metal precursor being put into the surface pores. The embedded particles can be catalytically active or inactive. In the latter case, another second metal or second metal compound, for example, a catalytic active material is deposited on top of the embedded inactive particles, thereby capping the pores. As schematically illustrated in FIG. 1, both cases result in a two-dimensional distribution of catalytic active particles over entire carbon surface with each of the particles anchored onto the carbon surface.

In another embodiment, the present particles, comprise, consist essentially of, or consist of a carbon support particle having a surface with a plurality of pores, filled by amorphous NbOx wherein 0≤x≤2 is the average number of oxygen per niobium and x can be an integer or non-integer. Each of the majority NbOₓ particles is enclosed by the carbon wall around it and a metal hemisphere on top of it. The metal hemisphere may be Pt. While Pt/C is commonly used for Pt nanoparticles weakly attached on a larger carbon particle, such a catalyst is termed as Pt—NbOx-C, in which “-” expresses a strong binding rather than a weak attachment. This type of core-shell structure increases utilization of precious metal by having them only on the top hemisphere. NbOx serves as an inexpensive and stable core for anchoring down Pt nanoparticles to minimize particle agglomeration after wide-range potential cycles. Tested for application as a catalyst for oxygen reduction reaction (ORR) in acidic media, the Pt mass activity of Pt—NbOx-C is more than twofold and sevenfold of that for Pt/C measured prior and post 50,000 potential cycles between 0.6 and 1.0 V at 50 mV s⁻¹. There is no loss in activity after 5,000 potential cycles between 1 and 1.5 V at 500 mV

In another embodiment, the present methods for forming the Pt—NbOₓ—C catalyst are described, the methods comprising, consisting essentially of, or consisting of providing a carbon based support particle having a surface with a plurality of about 4 nm pores; creating a mixture by adding the carbon based support particle to a solution or slurry of a Nb(V) precursor compound in a solvent; agitating the mixture; drying the particles of the mixture; exposing the particles to heat and a reducing gas; combining the particles with a metal salt solution; and reducing the metal of the metal salt solution.

In another embodiment, the present methods for forming an electrocatalytic particle, the methods comprising, consisting essentially of, or consisting of providing a carbon support particle having a surface with a plurality of pores; creating a mixture by adding the carbon support particle to a liquid solution of a Nb(V) compound with a specified ratio of carbon weight to solution volume; sonicating the slurry for sufficient time until all of the liquid is absorbed into the carbon; drying the mixture in a vacuum oven; exposing the dried mixture to heat and reducing gas; combining the NbOx-embedded particles with a solution containing Pt ions; and letting Pt spontaneous deposition on NbOx to occur or with asserted by adding mild reducing agent (e.g., ethanol).

### BRIEF DESCRIPTION OF DRAWINGS

FIG. 1A Schematically illustrates two ways of utilizing about 4 nm pores on the surface of an about 30 nm carbon particle in synthesis for anchoring down catalytic active particles (e.g., Pt) directly (arrow tilt upward) on carbon or indirectly via embedded metal oxide particles (e.g., NbOx) (leveled arrows).

FIG. 1B. Barrett-Joyner-Halenda (BJH) pore-size distribution for two carbon support materials.

FIG. 2. (Left) X-ray diffraction (XRD) profiles for two samples containing the same 3 μmol Nb per mg of carbon after thermal treatment in hydrogen at 220° C. for 1 h, 650° C. for 1 h and 900° C. for 30 m. (Right) Schematic models of the types of particles in the samples made using Ketjenblack EC 600JD (KB) and Vulcan XC-R72 (VC).

FIG. 3. Transmission electron microscopy (TEM) images for Nb oxides formed with VC (3A) and KB (3B). FIG. 3C shows a higher amplification Scanning transmission electron microscopy (STEM) image for the sample made with KB.

FIG. 4. Thermogravimetric analysis (TGA) curves measured for KB, KB mixed with NbO2, and NbOx embedded in KB.

FIG. 5. Voltammetry curves of the first and second cycles started at the low potential limit for a freshly prepared NbOₓ—C sample in Ar-saturated 0.1 M HClO₄ solution at 50 mV s⁻¹ sweep rate.

FIGS. 6A-6B. (6A) XRD for a Pt—NbOx-C sample made by Pt deposition via galvanic reaction between embedded NbOx particles and Pt ions in aqueous K2PtCl4 solution. (6B) High resolution STEM image showing ordered Pt atoms (bright dots) on amorphous NbOx (grey area).

FIGS. 7A-7B. (7A) ORR polarization curve for a Pt—NbO2-C sample in comparison with that of a Pt/C sample measured in O2-saturated 0.1 M HClO4 solutions at a sweep rate of 10 mV s−1 with rotation rate of 1,600 rpm. Both samples have 0.02 mg cm-2 Pt loading. (7B) Pt mass activities at 0.9 V before and after 10,000 (10K), 30,000 (30K), and 50,000 (50K) potential cycles between 0.6 and 1.0 V at 50 mV s⁻¹.

FIGS. 8A-8B. ORR polarization and voltammetry (insert) curves for a Pt—NbO2-C (8A) and a Pt/C (8B) samples measured before and after 5,000 (5K) potential cycles between 1-1.5 V at 500 mV s⁻¹.

### DETAILED DESCRIPTION

The present invention provides a carbon support particle having a metal or metal compound embedded therein and a carbon support having a catalytically inactive material embedded therein and a catalytically active metal or metal compound deposited on top of the catalytically inactive material, and methods of making the same.

The carbon support particle includes a surface having a plurality of pores. The pores may be uniform in distribution across the particle surface, diameter, and depth. Carbon support particles can have a spherical shape, non-spherical shape, polyhedral shape, or octahedral shape. The carbon support particles may be in the form of sheets, tubes, or hollow tubes.

In one embodiment, the carbon support particle has a minimum average diameter of about 10 nm, about 20 nm, or about 30 nm. In one embodiment, the carbon support particle has a maximum diameter of about 100 nm, about 80 nm, about 50 nm, or about 40 nm. In one embodiment, the average diameter is 30 nm.

In one embodiment, the carbon support particle has an average diameter between about 10 nm to about 100 nm, about 20 nm to about 80 nm, or between about 20 nm to about 50 nm. The carbon support particle may be a nanoparticle.

In one embodiment, the pores of the carbon support particle have a minimum average diameter of about 1 nm, about 2 nm, or about 3 nm. In one embodiment, the pores of the carbon support particle have a maximum diameter of about 50 nm, about 20 nm, about 10 nm, or about 5 nm.

The pores have a depth of between about 1 nm and about 7 nm. In one embodiment, the pores have an average depth of between about 2 nm and about 5 nm. In one embodiment, the pores have an average depth of between about 3 nm and about 4 nm.

In one embodiment, the pores of the carbon support particle have an average diameter of between about 1 nm to about 50 nm, between about 1 nm to about 20 nm, between about 1 nm to about 10 nm, or between about 2 nm to about 5 nm. In one embodiment, the pores of the carbon support particle have an average diameter of about 4 nm.

In one embodiment, the carbon support particle has a diameter of about 30 nm, an average pore size of about 4 nm, and pore depth of about 3 nm to about 4 nm.

Examples of carbon support particles include superconductive carbon black, such as for example Ketjenblack EC 600JD and Ketjenblack 300J (KB). The carbon support particle may be in the form of a soft pellet or a fine powder. These carbon support particles have similar particles sizes, about 30 nm in diameter, differing in specific surface area, as measured by N₂ adsorption. These carbon support particles may have uniformly distributed or substantially uniformly distributed pores on the surface. The pores may be an average diameter of about 4 nm and an average depth of about 3-4 nm. The specific surface area of KB may be due to its pore size diameter, i.e., about 4 nm pores, on its surface. Ketjenblack EC 600JD has a BET surface area of approximately 1270 m²/g and Ketjenblack 300J has a BET surface area of approximately 800 m²/g. Smaller sized particles yield higher specific surface area, which may be particularly useful for catalytic and battery applications.

A metal or metal compound is embedded into the pores of the carbon support particle. In one embodiment, the metal or metal compound is embedded into substantially all of the pores of the carbon support particle. Embedding metal or metal compound into the pores of a carbon surface can promote activity and durability of metal catalysts for electrochemical reactions. As used herein, “embedded” refers to a positional relation in which a guest object (metals or metal compounds) is at least partially enclosed by walls in a host object (carbon based support particle having a plurality of pores, said pores providing inner walls) such that the guest object is in contact with the walls, wherein the walls are all made of the same material composition (carbon). The guest object is therefore within the pores of the host object with the top surface exposed.

In one embodiment, the guest object may be a catalytic active metal, a metal alloy, or a metal compound being deposited in the small and uniformly distributed surface pores on carbon support particles by firstly filling the pores with solutions containing the metal salts. The metal precursors dried inside the pores are reduced to metal or metal alloy or metal compound particles by exposure to heat and a reducing gas, such as hydrogen, carbon monoxide, ammonia, and methane. The guest particles embedded in the surface pores can be metal, metal alloy, oxides, nitrides, and carbides.

In one embodiment, the catalytically active metal includes any catalytically active metal capable of being reduced.

In one embodiment, the catalytically active metal includes any noble metal. In another embodiment, the catalytically active metal includes any platinum group metal.

Examples of suitable catalytically active metals include noble metals, such as, ruthenium (Ru), rhodium (Rh), palladium (Pd), silver (Ag), rhenium (Re), osmium (Os), iridium (Ir), platinum (Pt), and gold (Au).

In one embodiment, the guest object includes more than one noble metal. For example, the guest object includes Pt and Pd. In another embodiment, the guest object is Pt and Ir. In another embodiment, the guest object is Pt and Ru.

In another embodiment, a carbon support particle may have a catalytically inactive material embedded in the surface pores and a catalytically active metal deposited thereon. Examples of catalytically inactive material include conductive metal oxides, nitrides, and carbides or non-precious metals.

As used herein, NbOₓ is used for Nb oxide without being specific for an oxidation state, or the number of O per Nb. NbOₓ includes NbO, NbO₂, or both, wherein x is an average number of oxygen (O) atoms per niobium (Nb) atom, where x may represent a mix between greater than 0 and less than or equal to 2. In one embodiment, x may be a non-integer value equal to or greater than 1 and less than or equal to 2. In one embodiment, x is 1 or 2, or a combination of 1 and 2.

In one embodiment, the NbOₓ embedded on the surface of the carbon support includes a mixture of NbOₓ having different values for x, wherein the value for x ranges from greater than 0 to less than or equal to 2.

As used herein “deposited” means the addition of one or more materials on a substrate, including, for example, the addition of a metal or metal compound onto NbOₓ.

The catalytically active metal can be deposited on a surface (e.g., a substrate surface, or exposed surface of NbOₓ) by methods that are well known to one of skill in the art. As used herein, “deposited on” a surface is intended to be broadly interpreted to include any suitable means of applying a catalytically active metal to the surface including, for example, deposition methods, coating methods, transfer methods, and/or other available application methods.

In one embodiment, at least one catalytically active metal described herein is deposited on NbOₓ, wherein the NbOₓ is first embedded onto a carbon support particle as described herein. Further description of depositing a metal on NbOₓ is described below.

The embedded NbOₓ and catalytically active metal thereupon is in substantially all of the pores of the carbon support particle to provide a substantially uniform surface.

In one embodiment, a carbon support particle may have NbOₓ and a catalytically active metal deposited thereupon. Such particle may define an electrocatalytic particle or electrocatalyst.

In another embodiment, a carbon support particle may have a catalytic inactive NbOₓ (0≤x≤2 on average for amorphous niobium oxide) embedded in the surface pores and is further covered by Pt on top (of the NBOₓ) to form a Pt—NbOₓ—C catalyst for ORR, which exhibits high Pt mass activity and excellent durability against potential cycles to 1 and 1.5 V.

Without wishing to be bound by theory, the catalytic active particles are formed on each of the surface pores via strong binding with the embedded material (e.g., NbOₓ) on the carbon support. In such a way, the metals are all in the top hemisphere (e.g., capping the pores) and thus better utilized, which may lead to higher mass activity and concurrently high stability against particle agglomeration. In one embodiment, the surface of the embedded material is partially capped. In another embodiment, the exposed embedded material is completely capped. In one embodiment, substantially all of the pores are capped with a metal.

Without wishing to be bound by theory, it is believed that it is the uniform pore size and uniform distribution across the entire surface of the carbon support particle, coupled with the uniform distribution of the NbOₓ and deposited metal thereupon, which provides the superior characteristics over the prior art.

Preferably, the amount of Nb₂O₅ in the particles described above should be minimized. Even more preferably, there is no Nb₂O₅ in the particles described above.

In one embodiment, the present composition includes a particle composition including a plurality of the particles described above.

### Method of Making a Metal-Nbₓ—C Electrocatalyst

In one embodiment, a method is provided for forming metal-Nbₓ-C electrocatalyst for ORR.

A carbon particle with embedded NbOₓ may be formed by first providing a carbon support particle, as described above. The carbon support particle is added to an ethanolic solution of a Nb(V) precursor compound to form a slurry containing carbon support particles and Nb(V) precursor. Suitable Nb(V) precursors include niobium (V) pentachloride or NbCl₅ and niobium (V) ethoxide or Nb(EtO)₅. The former, NbCl₅ (yellow) reacts with solvent ethanol to form Nb(EtO)₅ (colorless). Water and moisture can cause formation of highly stable Nb₂O₅ (white solid), which needs to be avoided. Preferably, the amount of Nb₂O₅ should be minimized. Even more preferably, there is no Nb₂O₅.

The slurry is agitated to aid in absorption of the solution into the carbon surface pores. Agitation may be accomplished by any method known in the art. An example of a suitable agitation method includes sonication. The slurry is agitated for a time sufficient for the solution to be absorbed into the carbon support particle. In one embodiment, the slurry is agitated for at least 1 hour, at least 2 hours, at least 3 hours, or at least 5 hours.

Without wishing to be bound by theory, it is believed that complete absorption of the solution into the carbon support provides the superior results over the prior art, as shown herein. On this basis, it is important to match the volume of metal precursor solution with the total pore volume of added carbon particles. The volume of metal precursor solution with the total pore volume may vary depending upon the specific characteristics of the carbon support and the nature of the metal precursor. The specific amount can be determined by a person of ordinary skill in the art, in view of the present disclosure.

For using Ketjenblack EC 600JD (KB) as the carbon support particles, the suitable carbon weight per solvent volume is in the range of 12 to 25 g L⁻¹; mostly likely about 20 g L⁻¹ for achieving no excess liquid at top of the slurry after more than 2 hours sonication. This ensures all metal precursors are absorbed into the surface pores so that no large metal particles form outside carbon particles during heat treatment.

The molar amount of Nb precursor per gram of KB may be 1 to 6 mmol; the suitable value is about 3 mmol

Without wishing to be bound by theory, confinement of the Nb(V) precursor in the nm-sized pores on the surface of the carbon based support particle maximizes the formation of NbOₓ particles with x being 1 or 0. Low oxidation state is preferred because conductivity and reducing power of NbOₓ increase with lowering x.

The slurry is dried in vacuum oven at about 70° C. to minimize moisture in air that can cause formation of hard to reduce Nb₂O₅. Drying may occur at any temperature suitable for this purpose. Additional examples of suitable drying temperatures include about 50° C. to 100° C. or 60° C. to 80° C. The resulting solid is ground into a fine powder. The particles are then exposed to heat and a reducing gas. A suitable reducing gas includes H₂. Examples of other suitable reducing gasses include ammonia, methane, and carbon monoxide.

The NbOₓ embedded carbon particles are then immediately combined with a metal salt solution after taking out of a tube furnace to avoid surface oxidation of NbOₓ. Examples of suitable metals include a noble metal, such as ruthenium (Ru), rhodium (Rh), palladium (Pd), silver (Ag), rhenium (Re), osmium (Os), iridium (Ir), platinum (Pt), and gold (Au). For example, suitable metal salt solutions include H₂PtCl₆ or K₂PtCl₄ or HAuCl₄.

Next, the metal of the metal salt solution is reduced.

Without wishing to be bound by theory, embedded NbO particles act as metal or Pt nucleation sites due to its ability to reduce PtCl₄²⁻ precursor in solution so that the growth of Pt nanoparticles are mostly on NbOₓ (x is close to 1, after Pt deposition, NbO likely becomes NbO₂). This structure is ideal for maximizing Pt utilization and enhancing particle stability against agglomeration. At the same time, conductive NbO₂ is protected by surrounding carbon and Pt on top so that its oxidation to non-conductive Nb₂O₅ is minimized. While many Nb-containing catalysts rarely match the Pt mass activity of Pt/C of the prior art, the present Pt-NbO₂—C catalysts exceed the mass activity of the prior art by at least 100%, while providing excellent durability against 0.6-1V and 1-1.5V potential cycles.

The high degree of dispersion and uniformity of NbOₓ particles over the entire carbon surface may be achieved by utilizing the surface pores on carbon. Controlling particle size and distribution by size and density of surface pores allow wide temperature ranges to be used in synthesis for fabricating small and well dispersed particles. The concept may be applied for making other metal, alloy, and oxide particles. High quality production can be made at low cost because the method does not use any chemical agents to control particle size.

The high degree of dispersion and uniformity of NbOₓ particles over entire carbon surface may be achieved by utilizing the surface pores on carbon. Controlling particle size and distribution by size and density of surface pores allow wide temperature ranges to be used in synthesis for fabricating small and well dispersed particles. The concept may be applied for making other metal, alloy, and oxide particles. High quality production can be made at low cost because the method does not use any chemical agents to control particle size.

Throughout this specification, quantities are defined by ranges, and by lower and upper boundaries of ranges. Each lower boundary can be combined with each upper boundary to define a range. The lower and upper boundaries should each be taken as a separate element.

In this specification, groups of various parameters containing multiple members are described. Within a group of parameters, each member may be combined with any one or more of the other members to make additional sub-groups. For example, if the members of a group are a, b, c, d, and e, additional sub-groups specifically contemplated include any one, two, three, or four of the members, e.g., a and c; a, d, and e; b, c, d, and e; etc.

Reference throughout this specification to “one embodiment,” “an embodiment,” “one example,” or “an example” means that a particular feature, structure or characteristic described in connection with the embodiment or example is included in at least one embodiment of the present embodiments. Thus, appearances of the phrases “in one embodiment,” “in an embodiment,” “one example,” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

In the specification, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Cited references, for which all their contents are incorporated herein in their entirety:
(1) Yu, X.; Ye, S. J. Power Sources 2007, 172 (1), 145-154.
(2) Sasaki, K.; Zhang, L.; Adzic, R. R. Phys. Chem. Chem. Phys. 2008, 10 (1), 159-167.
(3) Zhang, L.; Wang, L.; Holt, C. M. B.; Navessin, T.; Malek, K.; Eikerling, M. H.; Mitlin, D. J. Phys. Chem. C 2010, 114 (39), 16463-16474.
(4) Bonakdarpour, A.; Tucker, R. T.; Fleischauer, M. D.; Beckers, N. A.; Brett, M. J.; Wilkinson, D. P. Electrochim. Acta 2012, 85, 492-500.
(5) Huang, K.; Li, Y.; Yan, L.; Xing, Y. RSC Adv. 2014, 4 (19), 9701.
(6) Wu, Q.; Liao, L.; Zhang, Q.; Nie, Y.; Xiao, J.; Wang, S.; Dai, S.; Gao, Q.; Zhang, Y.; Sun, X.; Liu, B.; Tang, Y. Electrochim. Acta 2015, 158, 42-48.
(7) Sun, W.; Sun, J.; Du, L.; Du, C.; Gao, Y.; Yin, G. Electrochim. Acta 2016, 195, 166-174.
(8) Zhang, L.; Wang, L.; Holt, C. M. B.; Zahiri, B.; Li, Z.; Malek, K.; Navessin, T.; Eikerling, M. H.; Mitlin, D. Energy Environ. Sci. 2012, 5 (3), 6156.
(9) Senevirathne, K.; Hui, R.; Campbell, S.; Ye, S.; Zhang, J. Electrochim. Acta 2012, 59, 538-547.
(10) Liu, Y.; Ji, C.; Gu, W.; Jorne, J.; Gasteiger, H. a. J. Electrochem. Soc. 2011, 158 (6), B614.

### EXAMPLES

The present Pt—NbOₓ—C catalyst is illustrated in further details by the following non-limiting examples.

### Example 1

### Embedding NbOₓ into carbon surface.

The pores on KB were filled with Nb precursor by sonication of ethanolic slurry containing 50 mg KB and 150 μmol of Nb(EtO)₅ in 2.5 mL ethanol for 2 or more hours until liquid was completed absorbed. Water or moisture in air can react with Nb(V) compounds to form the most stable Nb₂O₅ (white solid) which should be avoid. The mixture was dried in vacuum oven for more than 3 hours and then grinded to fine powder. Thermal decomposition of Nb(EtO)₅ and reduction of Nb(V) were carried out in a tube furnace with hydrogen as reductant for 1 hour at 220° C., 1 hour at 650° C., and 0.5 hour at 900° C.

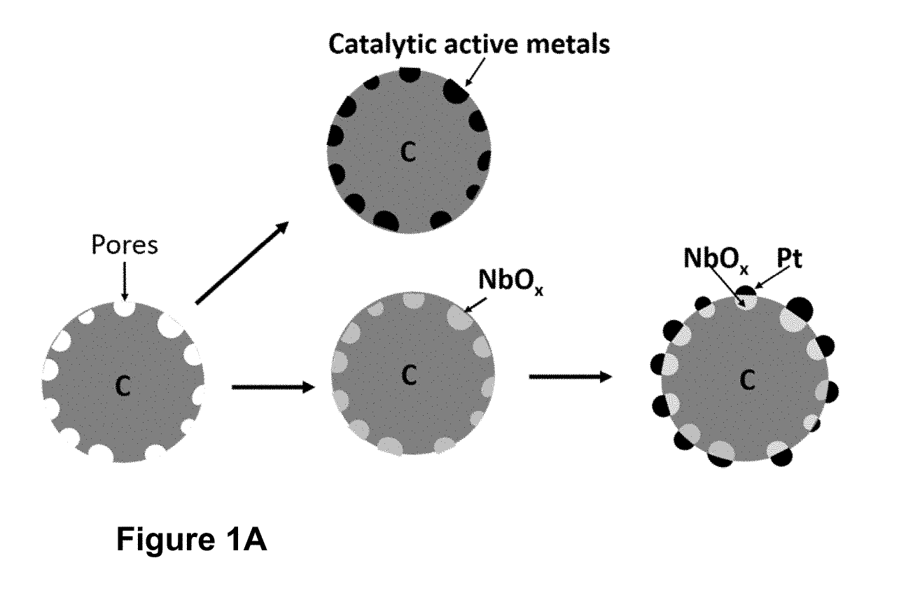

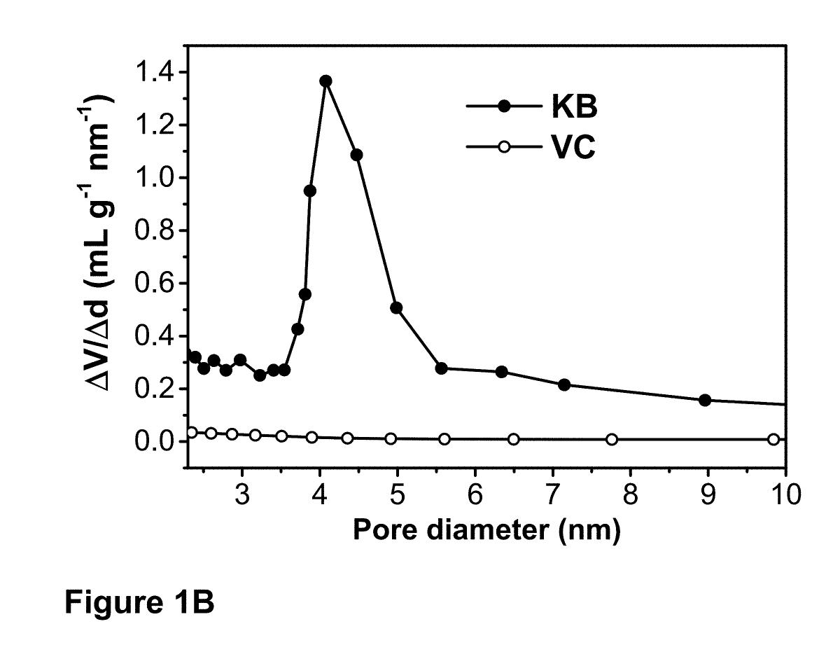

To show the effect of surface pores on carbon on reducing Nb(V) precursor to low oxidation state oxide particles, samples were made, using the same procedure, with KB and VC, the latter does not have a plurality of small surface pores. These two carbon materials have similar particles sizes, about 30 nm in diameter, differing in specific surface area, as measured by N₂ adsorption. The differing specific surface area between VC and KB is due to KB having many pores (≤4 nm in diameter) on the surface. [Liu et al., J. Electrochem. Soc. 2011, v 158, B614]. This is due to KB has a plurality of surface pores of about ˜4 nm in diameter as evidenced by the peak in the Barrett-Joyner-Halenda (BJH) pore-size distribution curve shown in FIG. 1B.

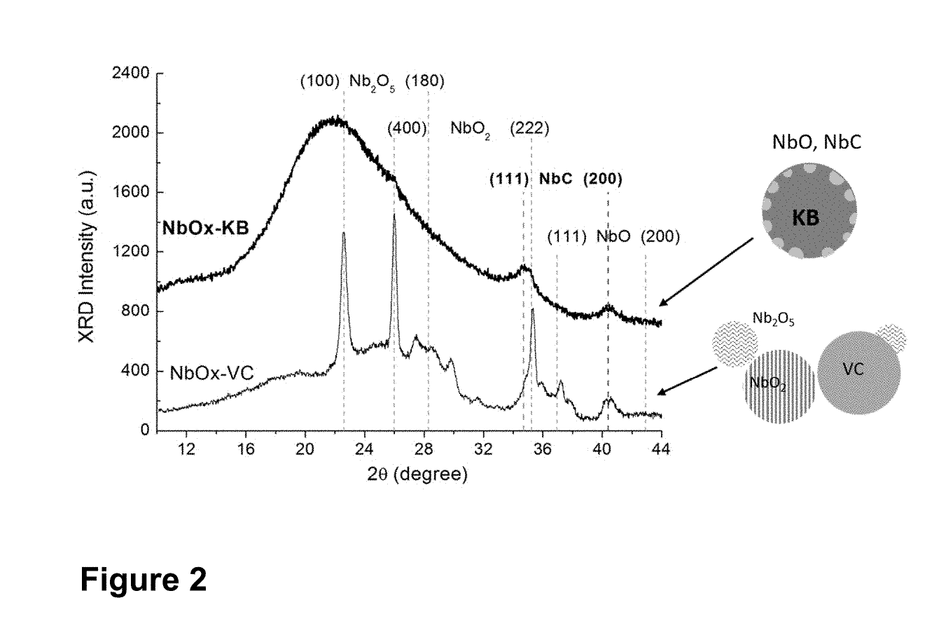

These samples exhibited different X-ray diffraction profiles as shown in FIG. 2. The curve at bottom for the sample made with VC exhibits sharp peaks for Nb2O5 and NbO₂, indicating formation of 20 to 30 nm Nb oxide particles with 5+ and 4+ oxidation states. In contrast, there are only two broad peaks at high angles in the curve on top for the sample made with KB, indicating that Nb(V) precursor dispersed in many small pores were more effectively reduced to lower oxidation state <2+, mixture of NbC and amorphous NbO. From the XRD peak widths, estimated particle size is 5 nm, significantly smaller than the NbO₂ and Nb₂O₅ particles formed on VC.

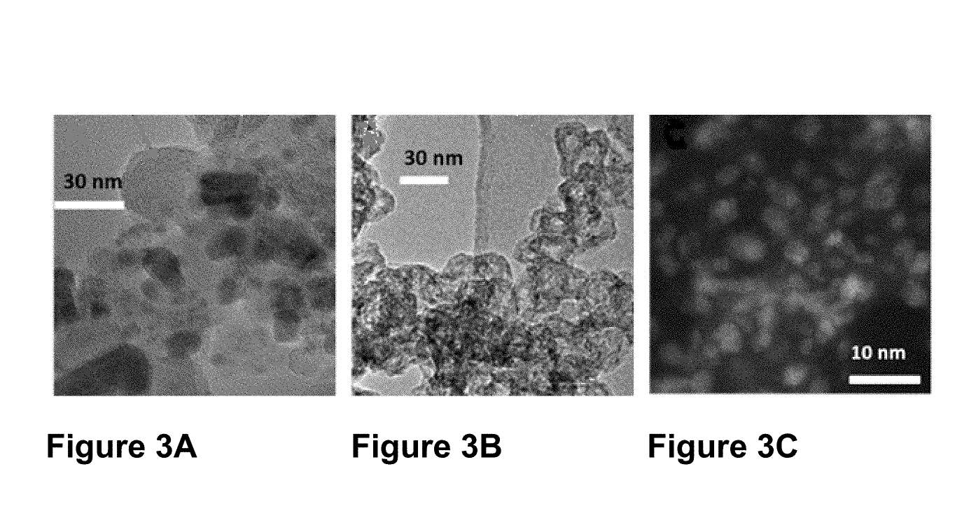

The high dispersion and uniformity of small NbOₓ particles on KB can be seen clearly by comparing the TEM images in FIG. 3A and 3B. For the sample made with VC there are about 30 nm NbO2 and Nb₂O₅ particles (darker spots) coexist with carbon particles (FIG. 3A). In contrast, the TEM image in FIG. 3B shows dark rings of about 30 nm in size resulting from small NbO particles embedded in the sub-surface of ˜30 nm carbon particles. For the particle size of embedded NbOₓ, higher amplification STEM image that made carbon invisible (FIG. 3C) shows that the NbO particles are mostly below 5 nm.

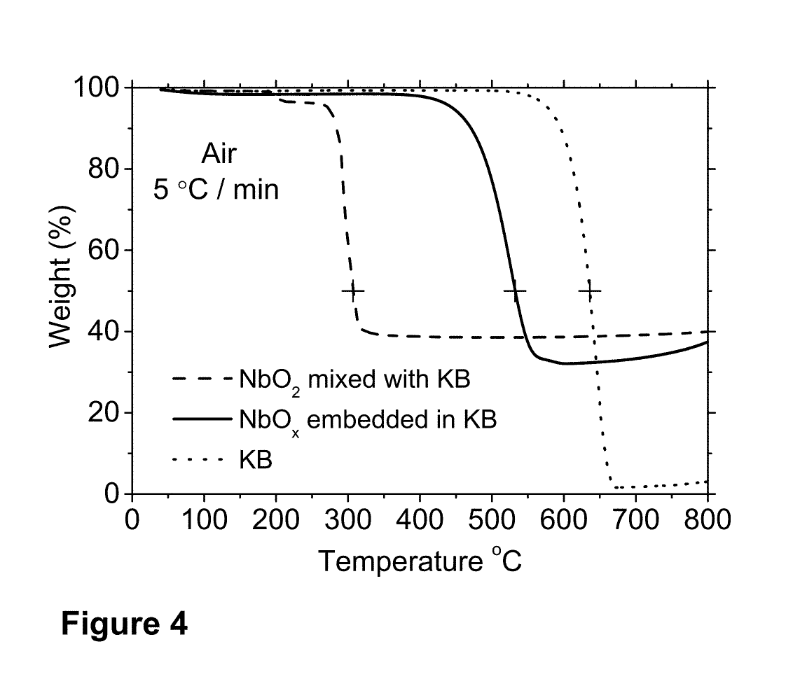

Further proof for the NbOₓ being embedded into carbon for the sample made with KB was obtained from thermogravimetric analysis (TGA) of three samples: C, C mixed with NbO₂ particles, and NbOₓ-C synthesized using Nb salt and KB. As shown in FIG. 4, the temperature for 50% weight loss due to carbon oxidation to gaseous CO₂ was lowered in the presence of NbO because exothermic oxidation of NbO₂ or NbO or Nb occurs at low temperature, which ignites or catalyzes carbon thermal oxidation that occurs above 600° C. on its own. Interestingly, for the sample of physically mixed NbO₂ and carbon particles, the temperature for 50% weight loss was lowered much more, 307° C. versus 532° C. This is attributed to physically mixed NbO₂ particles being most exposed to air than embedded NbOₓ, and thus, thermal oxidation occurs at a lower temperature. Moreover, the solid curve in FIG. 4 shows a small weight gain above 650° C., which is consistent with embedded NbO being partly protected from oxidation by surrounding carbon at low temperatures and its full oxidation to Nb₂O₅ is completed after carbon burned off. The dashed line for the sample with NbO₂ particles being outside carbon is flat after weight loss because NbO₂ oxidation to Nb₂O₅ completed during carbon loss. These distinct differences support NbO being embedded in carbon.

### Example 2

### Low Nb Oxidation State Illustrated by Electro-Oxidation Current Peak

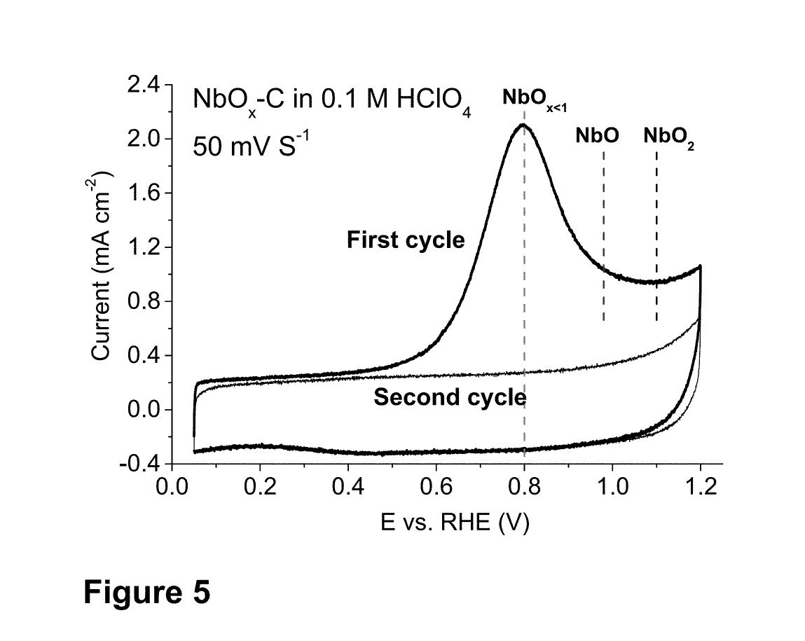

A thin layer of most stable Nb₂O₅ forms on low-oxidation-state NbOₓ once the samples were exposed to oxygen in air or brought into water, which then inhibits bulk oxidation at room temperature. To observe electro-oxidation of NbO surface, inks of freshly prepared NbOₓ—C samples were made using ethanol and iso-propanol in 6:1 volume ratio, and drop casted the ink on to a glassy carbon rotating disk electrode (RDE). FIG. 5 shows an irreversible current peak at 0.8 V in the first positive potential sweep, which indicates the average x<1 because studies using well characterized thin films have shown that the peak potential is lower for NbO (˜0.98 V) than for NbO₂ (above 1.1 V). [Zhang, L.; Wang, L.; Holt, C. M. B.; Navessin, T.; Malek, K.; Eikerling, M. H.; Mitlin, D. J. Phys. Chem. C 2010, 114 (39), 16463-16474] The low peak potential and high integrated net charge observed suggest that the Nb (V) precursor was mostly reduced to NbC and NbO. Some are in crystalline form as seen by the weak XRD peak and some are amorphous.

In summary, the examples above describe utilizing the small pores on KB to fabricate well dispersed NbO nanoparticles with size <5 nm stabilized in the sub-surface of carbon. More specifically, describing NbO nanoparticles embedded in the pores of the carbon based support particle.

### Example 3

### Pt Deposition on NbOₓC

The reducing power of the portion of embedded NbOₓ exposed on the surface was utilized to create Pt nucleation via galvanic reaction between NbOₓ and Pt precursor in solutions. Further Pt particle growth may be assisted by adding mild reducing agents, such as ethanol or citric acid.

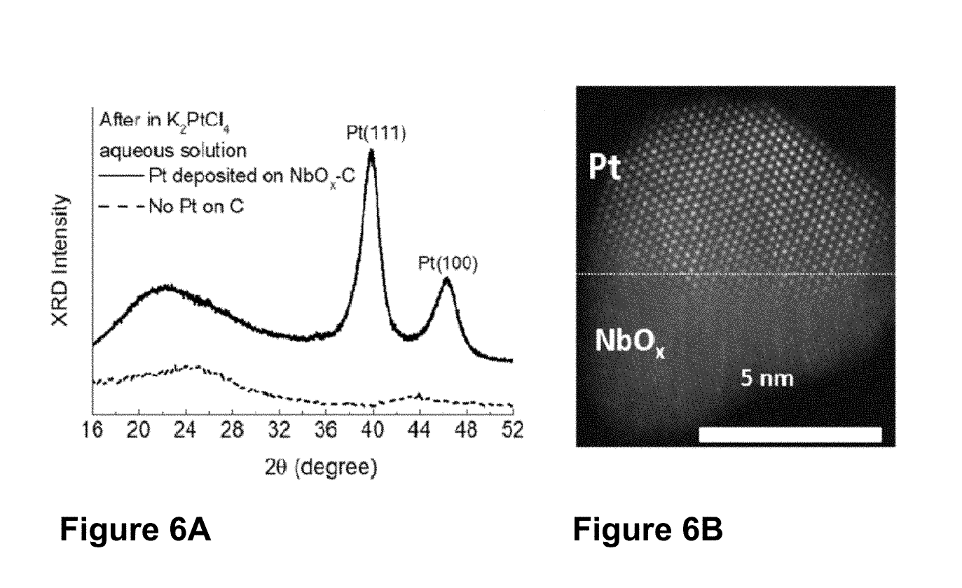

FIG. 6A shows the XRD for a sample made by immersing NbOₓ-C made using KB in deaerated K₂PtCl₄ aqueous solutions at 45° C. with stirring for 4 to 5 hours. Without any other chemicals, the emerged Pt (111) and (100) diffraction peaks at 39.76 and 46.23 degrees, respectively, show the formation of Pt particles via galvanic reduction by NbOₓ. In comparison the XRD curve for KB treated in the same way exhibited no diffraction for Pt, confirming Pt deposition does not occur on carbon surface. Estimated from the Pt(111) peak, average Pt particle sizes are 5.3 nm and 4.5 nm for the samples made with Pt:Nb atomic ratio in precursors being 1 and 0.5, respectively, which is close to the about 5 nm average NbOₓ particle size.

The strong binding between Pt and NbOₓ is illustrated by a high-resolution STEM image of a single Pt particle shown in FIG. 6B. Pt atoms (bright dots due to its high electron density) form ordered lattice on top of amorphous NbOₓ (less bright due to lower electron density of Nb and having oxygen in the lattice). The diameter of hemisphere of Pt matches that of NbOₓ. Carbon surrounding the NbOₓ particle is invisible due to its very low electron density in this Z-contrast image. This structure is ideal for high utilization of Pt with superior durability because Pt particles are well dispersed and anchored down on carbon surface via chemical bonding with embedded NbOₓ.

### Example 4

### Activity and Durability of Pt—NbOₓC Catalyst for ORR

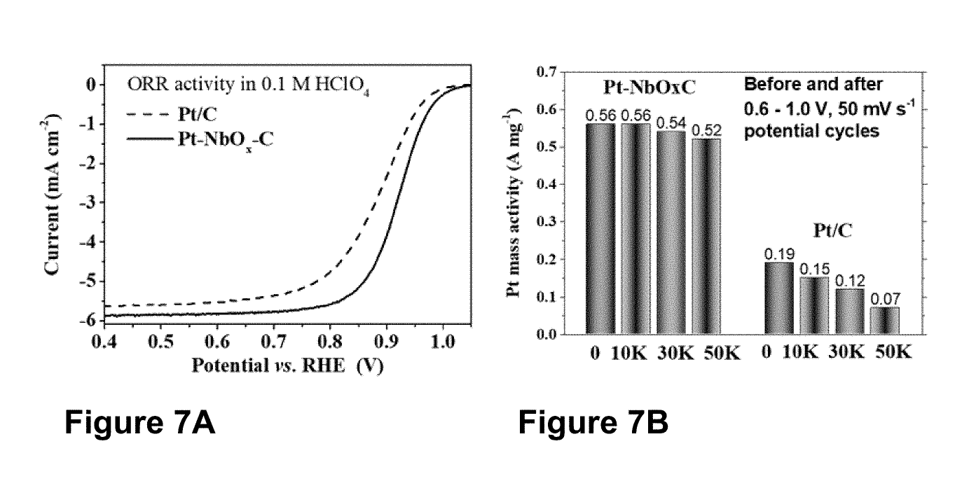

Evaluation of the Pt—NbOₓ—C catalysts was performed on rotating disk electrode in 0.1 M HClO₄ solutions with the Pt content in the catalyst determined catalyst as by inductive coupled plasma mass spectrometry (ICP). Compared to Pt nanoparticles attached on carbon support (Pt/C), the ORR polarization curve for Pt—NbOₓ—C catalyst exhibited larger ORR currents at higher potentials in FIG. 7A. These polarization curves were measured after potential cycles between 0.6 and 1.0 V at 50 mV s⁻¹ for evaluating the catalysts' durability under fuel cell load cycle conditions. The Pt mass activities at 0.9 V were summarized in FIG. 7B. While the Pt mass activity on Pt/C decreased from 0.19 to 0.07 A mg⁻¹ after 50,000 or 50K cycles, initial 0.56 A mg⁻¹ activity only lowered to 0.52 A mg⁻¹ for the Pt—NbOₓ—C catalyst.

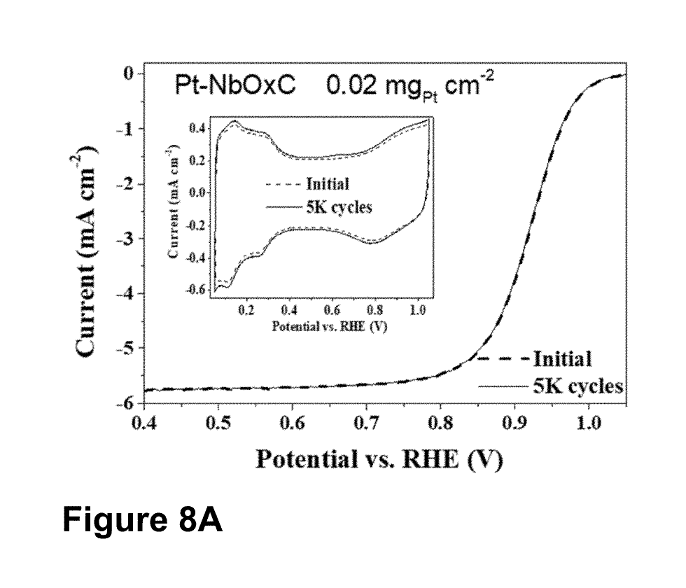

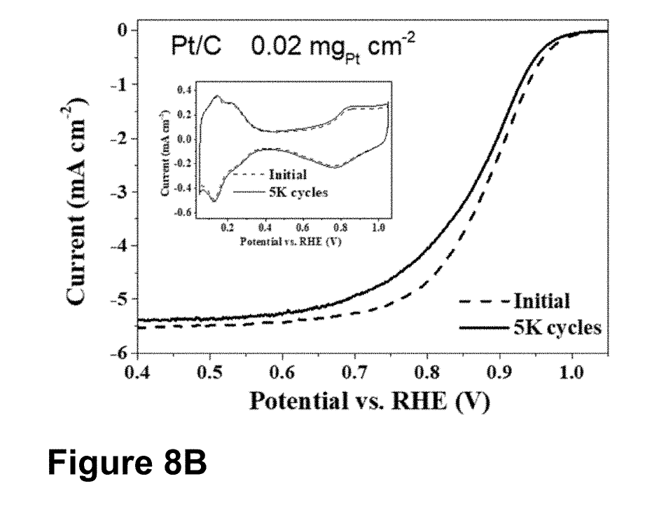

Durability against 1 to 1.5 V potential cycles at 50 mV s⁻¹ that corresponds to the fuel cell startup-shutdown cycles is also tested. As shown in FIG. 8, after 5000 potentials cycles, there are no loss of ORR activity and Pt surface area for the Pt—NbOₓ—C sample as the ORR polarization curves and the voltammetry curves in the insert of FIG. 8A are essentially the same before and after the 5000 potential cycles. In comparison, the ORR polarization curve measured for Pt/C shifted to lower potentials as shown in FIG. 8B.

The enhanced Pt mass activity and catalyst durability is ascribed to the high density of about 5 nm hemisphere Pt particles anchored down on carbon surface via embedded NbOₓ. A common issue for other catalysts involving conductive NbO or NbO₂ is increased resistance of initially low-oxidation-state oxides being oxidized to nonconductive Nb₂O₅. This issue is largely alleviated by enclosing NbOₓ by surround carbon and Pt on top to prevent its oxidation to Nb₂O₅. Even Nb₂O₅ eventually form, the impact on ORR activity is limited because these particles are only about 5 nm and within conductive carbon.

In the example of a catalytic application, embedded NbO serves as the nucleation sites for growing Pt particles on it, not an inactive support. Pt particles formed are strongly bounded with NbOₓ with a semi-spherical shape. These particles are separated from each other as their location is determined by the surface pores. Conductive NbO or NbO₂ are made less prone to electro-oxidation than non-conductive Nb₂O₅ by having them being protected by the surrounding carbon and Pt on top. These unique and desirable features may contribute to the high ORR activity and durability against potential cycles up to 1.5 V.

The high degree of dispersion and uniformity of NbO particles over entire carbon surface may be achieved by utilizing the surface pores on carbon. Controlling particle size and distribution by size and density of surface pores allow wide temperature ranges to be used in synthesis for fabricating small and well dispersed particles. The concept may be applied for making other metal, alloy, and oxide particles. High quality production can be made at low cost because the method does not use any chemical agents to control particle size.

While there have been described what are presently believed to be the preferred embodiments of the present invention, those skilled in the art will realize that other and further changes and modifications may be made thereto without departing from the spirit of the invention, and it is intended to claim all such modifications and changes as come within the true scope of the invention.

1. A particle comprising:
a carbon support particle having a surface with a plurality of pores; and
a first metal or first metal compound within or capping the plurality of pores.

2. The particle according to claim 1, wherein the first metal compound is NbOₓ, and NbOₓ is embedded in at least one of the plurality of pores, wherein x is a number greater than 0 and equal to or less than 2; and
a second metal or second metal compound is catalytically active and is deposited on the NbOₓ.

3. The particle according to claim 2, wherein x is 1 or 2.

4. The particle according to claim 1, wherein the catalytically active metal comprises a noble metal.

5. The particle according to claim 4, wherein the noble metal comprises at least one metal selected from ruthenium (Ru), rhodium (Rh), palladium (Pd), silver (Ag), rhenium (Re), osmium (Os), iridium (Ir), platinum (Pt), and gold (Au).

6. The particle according to claim 1, wherein the carbon support particle has an average diameter of between about 10 nm to about 100 nm.

7. The particle according to claim 1, wherein the carbon support particle has an average diameter of between about 20 nm to about 80 nm.

8. The particle according to claim 1, wherein the pores have an average diameter of between about 1 nm to about 20 nm.

9. The particle according to claim 1, wherein the pores have an average diameter of between about 1 nm to about 10 nm.

10. The particle according to claim 1, wherein the pores have an average diameter of between about 2 nm to about 6 nm.

11. The particle according to claim 2, wherein the catalytically active metal covers any exposed surface of the NbOₓ.

12. A composition comprising:
a plurality of particles, said particles comprising:
a carbon support particle comprising a surface with a plurality of pores having an average diameter of between about 2 nm and 6 nm, and said particle having a diameter of between about 20 nm to about 80 nm; and
a first metal or first metal compound within or capping substantially all of the plurality of pores.

13. The composition according to claim 12, wherein the first metal compound is NbOₓ and is embedded within at least one of the plurality of pores, wherein x is a number greater than 0 and equal to or less than 2; and
a second metal or second metal compound is catalytically active and is deposited on NbOₓ.

14. The composition according to claim 13, wherein x is 1 or 2.

15. The composition according to claim 12, wherein the first metal or first metal compound is catalytically active metal and comprises at least one metal selected from ruthenium (Ru), rhodium (Rh), palladium (Pd), silver (Ag), rhenium (Re), osmium (Os), iridium (Ir), platinum (Pt), and gold (Au).

16. A method for forming an electrocatalytic particle, the method comprising:
providing a carbon support particle having a surface with a plurality of pores;
creating a mixture by adding the carbon based support particle to a precursor solution;
agitating the slurry until all of the solution is absorbed in pores;
drying the mixture in vacuum oven at a temperature range of about 50° C. to 100° C.;
exposing the dried mixture of NbOₓ-embedded carbon particles to heat and a reducing gas;
combining the NbOₓ-embedded carbon particles with a metal salt solution; and
reducing the metal of the metal salt solution.

17. The method of claim 16, wherein the agitation is sonication for at least 1 hour, at least 2 hours, or at least 5 hours.

18. The method of claim 16, wherein the precursor solution is an ethanolic solution of Nb(V).

19. The method of claim 16, wherein the reducing gas is selected from the group consisting of hydrogen, ammonia, methane, and carbon monoxide.

20. The method of claim 16, wherein the metal salt solution is aqueous K₂PtCl₄ solution and reduction of Pt is by way of galvanic interaction with NbOₓ in deaerated solution.
